(19) United States
(12) Patent Application Publication
(10) Pub. No.: US 2005/0073939 A1
(43) Pub. Date: Apr. 7, 2005

(54) Shading-information acquisition device and image processing apparatus

(75) Inventors: Yoshiyuki Sakaguchi, Otsu-shi (JP); Junichi Kita, Tonami-shi (JP)

Correspondence Address: CASELLA & HESPOS, 274 MADISON AVENUE, NEW YORK, NY, 10016, US

(73) Assignee: DIGITAL FASHION LTD., Osaka-shi (JP)

(21) Appl. No.: 10/958,321

(22) Filed: Oct. 5, 2004

(30) Foreign Application Priority Data
Oct. 7, 2003 (JP) 2003-348792

(51) Int. Cl. G11B 7/00; G06T 15/50

(52) U.S. Cl. 369/125

(57) ABSTRACT

An image processing apparatus and a shading-information acquisition device have a sample table (21) adapted to rotate in a direction (θ1) about a rotational axis (Z1) and to rotate in a direction (θ2) about a rotational axis (Z2). An irradiation assembly (3) includes a support plate (31) adapted to rotate in the direction (θ1) about the rotational axis (Z1), an irradiation arm (33) adapted to rotate in a direction (θ3) about the rotational axis (Z3) and provided with a light radiation aperture (331) at the top end thereof. An optical fiber cable (36) guides light from a light source unit (34) to the light radiation aperture (331), and a camera (4) is disposed outside a dark box (6). The image processing apparatus and shading-information acquisition device perform a realistic shading processing for a virtual 3-dimensional model by a simple operation without complicated jobs for setting up various parameters.

### BACKGROUND OF THE INVENTION

1. Field of the Invention

The present invention relates to a shading-information acquisition device and an image processing apparatus.

2. Description Of The Related Art

A virtual 3-dimensional model created in a virtual 3-dimensional space on a computer is drawn (or rendered) on a virtual screen located at a given position in the virtual 3-dimensional space, while taking account of the respective positions of a virtual camera and a light source which are arranged in the virtual 3-dimensional space, and the influences, such as reflection and refraction in the virtual 3-dimensional space, of a light virtually emitted from the light source, and then an image drawn on the virtual screen is displayed on a display. During the rendering process, the virtual 3-dimensional model is subjected to a shading processing in consideration of the influences of the light emitted from the virtual light source, the material of the virtual 3-dimensional model, and other factors. In a conventional image processing apparatus, the shading processing has been performed based on parameters set by an operator.

However, a realistic shading processing can be achieved only if the parameters are accurately set up. Thus, it has been difficult for beginners to perform the shading processing requiring a lot of skill. In addition, even a skilled person has been required to spend an enormous amount of time and effort in the shading processing.

In particular, a fibrous structure, such as cloth or fabric, has optical anisotropy in which the reflectance and diffusion of light are varied depending on the incident angle of the light thereon. Thus, in order to perform a realistic shading processing for a virtual 3-dimensional model consisting of such a fibrous structure, it is required to further accurately set up various parameters, such as ambient light (ambient), diffused light (diffuse) and reflected light (specular) in the virtual 3-dimensional space. That is, not only beginners but also skilled persons have not been able to achieve the realistic shading processing without spending an enormous amount of time and effort.

### SUMMARY OF THE INVENTION

In view of the above problems, it is therefore an object of the present invention to provide an image processing apparatus and a shading-information acquisition device capable of performing a realistic shading processing for a virtual 3-dimensional model by a simple operation without complicated jobs for setting up various parameters.

In order to achieve this object, the present invention provides a shading-information acquisition device for acquiring shading informations to be used in rendering a virtual 3-dimensional model which is created in a virtual 3-dimensional space. The shading-information acquisition device comprises: a table for mounting an actual sample thereon, which is adapted to be rotated by a given angle about a first axis extending in a direction orthogonal to the surface of the sample mounted thereon and to be rotated by a given angle about a second axis extending in a direction orthogonal to the first axis; image pickup means for picking up an image of the actual sample mounted on the table, from a given direction; and irradiation means for irradiating the actual sample with light. The irradiation means is adapted to move one end of the axis of the light along a sphere-shaped plane located above the table.

According to the shading-information acquisition device of the present invention, the table is rotated about the first axis and the second axis orthogonal to the first axis. Further, the actual sample mounted on the table is irradiated with a light having a light axis with one end which is moved along a sphere-shaped plane above the table to change the light axis direction. Thus, the image pickup means can pickup optical images in the same state as that when the image pickup means is moved along the sphere-shaped plane. That is, even if the image pickup means is set up at a fixed position, it can pickup the same optical images as those to be obtained by actually moving image pickup means along the sphere-shaped plane. This eliminates the restrictions to be imposed on the image pickup means due to such a movement, for example, restriction requiring to select a small-size/lightweight image pickup means. Thus, a high-performance image pickup means can be used without taking account of such restrictions. Therefore, the shading informations can have enhanced image quality to allow a rendering processing for rendering the virtual 3-dimensional model to be further realistically performed.

If a light source of the radiation means is moved along the sphere-shaped plane while moving the image pickup means therealong, they will overlap with one another at a number of positions to cause difficulties in acquiring shading informations at these positions. By contrast, in the present invention, the number of positions precluding the acquisition of shading informations is limited to one because the image pickup means is not moved. In addition, any mechanism for moving the image pickup means can be eliminated to allow the device to have a simplified structure.

In the shading-information acquisition device of the present invention, the irradiation means may include: a first arm attached to the table in a rotatable manner about an axis extending in a vertical direction; an arch-shaped second arm having a top end provided with a light radiation aperture, and the other end attached to the first arm in a rotatable manner about an axis extending in the longitudinal direction of the first arm; a light source; and light guide means for guiding light from the light source to the light radiation aperture.

According to this structure, one end of the light axis can be moved along the sphere-shaped plane to set up the light axis direction by the simplified structure having only two components of the first and second arms. Further, light from the light source is guided to the light radiation aperture through the light guide means. This eliminates restrictions to be imposed on the light source as in case where the light source is attached directly to the light radiation aperture, for example, restriction requiring to select a small-size/lightweight image pickup means in consideration of the movement of the light source.

Further, the light guide means may be an optical fiber cable including an optical fiber bundle.

In this case, the optical fiber cable used as the light guide means can provide enhanced flexibility during movement of the irradiation means, and can guide light from the light source to the light radiation aperture with high efficiency.

The shading-information acquisition device of the present invention may further include a dark box covering over the periphery thereof. In this case, a light source of the light radiation means and the image pickup means may be disposed outside the dark box, and the dark box may be formed with an image-pickup hole for allowing the imaging means to pick up an image of the actual sample therethrough.

According to this structure, the device components contained in the dark box can be shielded from external light to provide shading informations with a higher degree of accuracy. Further, the image pickup means and the light source are disposed outside the dark box. This arrangement makes it possible to facilitate the maintenance or replacement of the image pickup means and the light source.

The present invention also provides an image processing apparatus comprising: a shading-information acquisition device for acquiring shading informations in accordance with images of an actual sample for respective image-pickup conditions defined by a parameter including an image pickup direction and a light radiation direction relative to the actual sample; a processing device for rendering a virtual 3-dimensional model created in a virtual 3-dimensional space, in accordance with the shading information acquired by the shading-information acquisition device. The processing device includes: shading-information storage means for storing the shading informations acquired by the shading-information acquisition device, in association with corresponding values of the parameter; parameter calculation means for calculating a specific parameter value corresponding to a given region of the virtual 3-dimensional model, in accordance with the respective positions of a virtual camera and a virtual light source which are arranged in the virtual 3-dimensional space, and the shape of the region of the virtual 3-dimensional model; and shading processing means for reading the shading information corresponding to the calculated parameter value from the shading-information storage means, and calculating a brightness value of the given region of the virtual 3-dimensional model, in accordance with the read shading information. The shading-information acquisition device includes: a table for mounting the actual sample thereon, which is adapted to be rotated by a given angle about a first axis extending in a direction orthogonal to the surface of the sample mounted thereon and to be rotated by a given angle about a second axis extending in a direction orthogonal to the first axis; image pickup means for picking up an image of the actual sample mounted on the table, from a given direction; and irradiation means for irradiating the actual sample with light. The irradiation means is adapted to move one end of the axis of the light along a sphere-shaped plane located above the table.

According to the image processing apparatus of the present invention, the shading processing can be performed using shading informations obtained by picking up images of the actual sample to carry out a realistic rendering process.

Other features and advantages of the present invention will be apparent from the accompanying drawings and from the detailed description.

### BRIEF DESCRIPTION OF THE DRAWINGS

FIG. 1 is a perspective view showing a shading-information acquisition device according to one embodiment of the present invention.

FIG. 2 is a block diagram showing the electrical configuration of an image processing apparatus incorporating the shading-information acquisition device.

FIG. 3A is a schematic explanatory diagram of the structure of the shading-information acquisition device.

FIG. 3B is a schematic explanatory diagram of the structure of a sample table 21 of the shading-information acquisition device.

FIG. 4 is a functional block diagram of a computer.

FIG. 5 is an explanatory diagram of a data structure in a shading-information storage section.

FIG. 6 is an explanatory diagram of a data structure in a shading-information storage section.

FIG. 7 is an explanatory diagram of a processing in a geometry-information acquisition section and a parameter calculation section.

FIG. 8 is a flowchart showing a processing of acquiring shading informations.

FIG. 9 is a flowchart showing a shading processing.

FIGS. 10A and 10B are explanatory diagrams of the processing in shading processing section, wherein FIG. 10A is a graph showing the relationship between brightness C and texture brightness T, and FIG. 10B is an explanatory diagram showing one example of a texture stored in a texture storage section.

FIGS. 11A and 11B are explanatory diagrams of the effect of an image processing in the image processing apparatus of the present invention, wherein FIG. 11A shows an image subjected to a shading processing using a conventional image processing apparatus, and FIG. 11B shows an image subjected to a shading processing using the image processing apparatus of the present invention.

### DESCRIPTION OF THE PREFERRED EMBODIMENTS

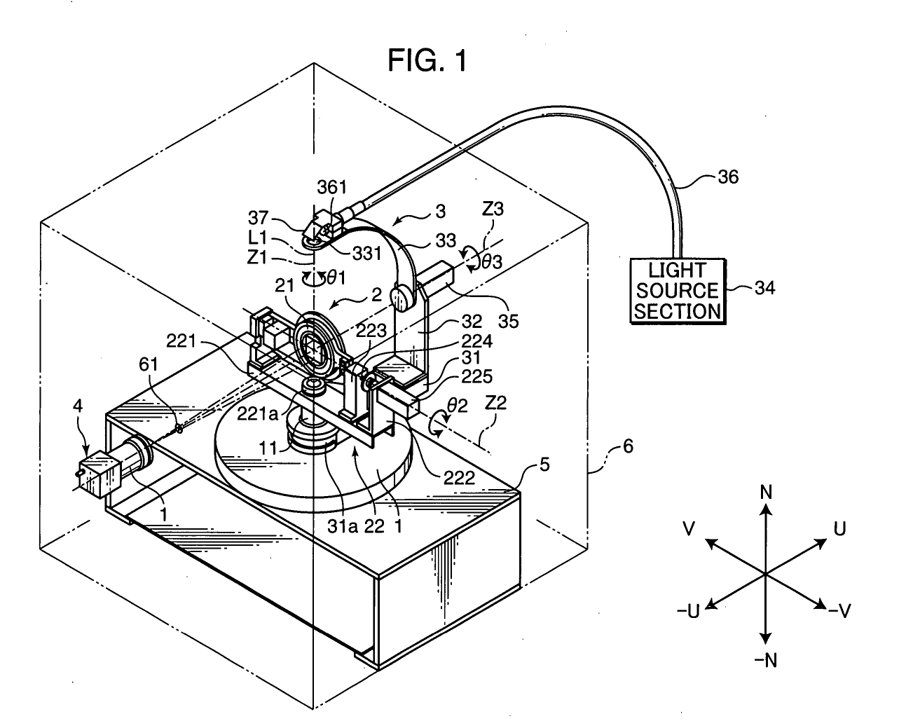

FIG. 1 is a perspective view showing a shading-information acquisition device according to one embodiment of the present invention. The shading-information acquisition device comprises a base 1, a table assembly 2 disposed on the upper side of the base 1 (in a direction +N relative to the base 1), an irradiation assembly 3 for radiating light from above the table assembly 2 toward an actual sample mounted on the table assembly 2, a camera 4 for picking up an image of the sample, a pedestal 5 disposed on the lower side of the base 1 (in a direction −N relative to the base 1), and a dark box 6 covering over the periphery of the device.

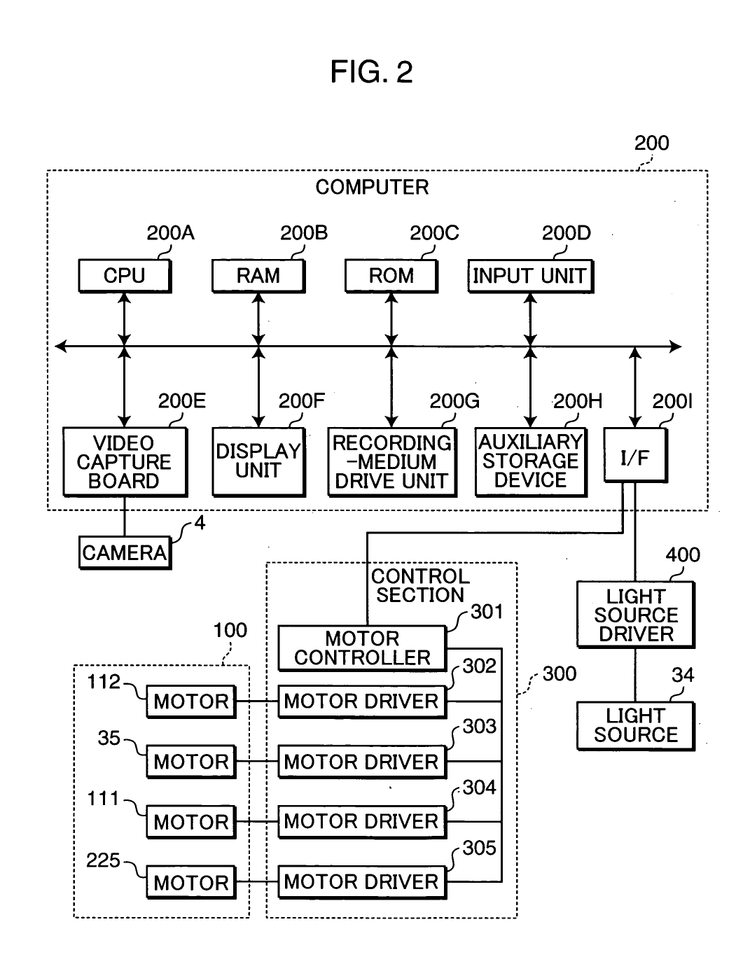

The base 1 has a disk shape, and a cylindrical shaft 11 stands upward from the central portion of the base 1. The table assembly 2 comprises a sample table 21 for mounting an actual sample thereon, and a connection unit 22 connecting between the shaft 11 and the sample table 21. The connection unit 22 includes a support plate 221 extending in a horizontal direction. The support plate 221 has a central portion 221a which is connected to the shaft 11 so as to allow the support plate 221 to be rotated by the shaft 11 in a direction θ1 on a horizontal plane (on a plane U-V). A motor 111 (not shown in FIG. 1, see FIG. 2) is incorporated in the shaft 11, and the connection unit 22 can be rotated (turned) in the direction θ1 in response to receiving a driving force of the motor 111. The longitudinal direction of the shaft 11 is defined as a rotational axis (central axis) Z1.

Two connection plates 222 and 223 stand upward from one end of the support plate 221, and a shaft 224 penetrates through the connection plates 222 and 223 in the horizontal direction. The shaft 224 has one end connected to the sample table 21, and the other end connected to a motor 225. For example, a stepping motor is used as the motor 225. A rotating shaft (not shown) of the motor 225 and the shaft 224 are connected together through a coupling. In response to receiving a torque from the motor 225, the shaft is rotated (turned) in a direction θ2. Thus, the sample table 21 is rotated (turned) relative to the connection unit 22 about a rotational axis (central axis) Z2 defined by the longitudinal direction of the shaft 224.

The irradiation assembly 3 comprises a support plate 31 having one end provided with a holder 31a through which the shaft 11 penetrates and extending in a horizontal direction, a connection plate 32 standing in a vertical direction (direction +N) from the other end of the support plate 31, an irradiation arm (corresponding to a second arm) 33 rotatably (swingably) connected to one end of the connection plate 32, a light source unit 34 disposed outside the dark box 6, a motor 35 for rotating the irradiation arm 33, and an optical fiber cable 36 including an optical fiber bundle to guide light from the light source unit 34 toward a light radiation aperture 331.

The motor 35 composed, for example, of a stepping motor, is operable to rotate the irradiation arm 33 in a direction θ3 about a rotational axis (central axis) Z3. When the irradiation arm 33 is positioned such that its longitudinal direction is parallel to the longitudinal direction of the connection plate 32, the irradiation arm 33 has an arch shape allowing an light axis L1 to intersect with the central portion 221a. The radiation aperture 331 is formed in the top end of the irradiation arm 33.

The light source unit 34 is composed of a metal halide lamp, a light-emitting diode or a laser diode. The end 361 of the optical fiber cable 36 on the side of the irradiation arm 33 is attached to the irradiation arm 33 by a fiber holder 37. A reflecting mirror (not shown) is disposed in front of the end 361 to allow light output from the end 361 to be reflected at an angle of 90-degree and directed toward the actual sample mounted on the table 21. A motor 112 (not shown in FIG. 1, see FIG. 2) is incorporated in the shaft, and the support plate 31 can be rotated (turned) in the direction θ1 through the holder 31a in response to receiving a torque of the motor 112.

The dark box 6 has a rectangular parallelepiped shape with a sidewall formed with an image pickup hole 61 for allowing the camera 4 to pickup an image of the actual sample. The shape of the dark box 6 is not limited to the rectangular parallelepiped shape, but may have any other suitable shape, such as a dome shape, capable of covering over the periphery of the device.

FIG. 2 is a block diagram showing the electrical configuration of an image processing apparatus incorporating the shading-information acquisition device 100. The image processing apparatus comprises the shading-information acquisition device 100, a computer 200, a control section 300 for controlling the mechanical operations or movements of the shading-information acquisition device 100, and a light source driver 400 for controlling the light intensity and on/off of the light source unit 34 under the control of the computer 200.

The computer 200 is composed of a conventional personal computer comprising a CPU (Central Processing Unit) 200A, a RAM (Random Access Memory) 200B, a ROM (Read Only Memory) 200C, an input unit 200D, a display unit 200F, a recording-medium drive unit 200G, an auxiliary storage device 200H, and an input/output interface (I/F) 200I.

The computer 200 further includes a video capture board 200E for acquiring an image of an actual sample picked up by the camera, for example, through a cable connected to a DV terminal compliant with IEEE Standard 1394. The CPU 200A to the I/F 200I are connected to each other through a bus line including an address bus and a data bus, so as to sent and receive various data mutually.

The input unit 200D is composed of a pointing device, such as a key board and a mouse. The display unit 200F is composed of a CRT (Cathode Ray Tube), a plasma display or a liquid crystal display. The recording-medium drive unit 200G is composed of a hard disk, to store an image processing program for allowing the computer 200 to serve as the image processing apparatus, and various application programs. The recording-medium drive unit 200G is operable to read and write data from/in a recording medium, such as flexible disks, CD-ROMs and DVD-ROMs.

The image processing program is provided in the form of data recorded on a recording medium, such as a flexible disk, a CD-ROM or a DVD-ROM. Then, the recording medium is loaded/installed in the recording-medium drive unit 200G to store the image processing program on the auxiliary storage device 200H. Alternatively, if the image processing program is stored on a server connected to the computer 200 through electrical communication lines, such as Internet, it will be downloaded from the server and installed in the recording-medium drive unit 200G to store the image processing program on the auxiliary storage device 200H. Further, the image processing program may be executed between the computer 200 and a WEB server provided on the Internet, in a decentralized manner, for example, in such a manner that various data are entered from the personal computer 200 into the WEB server to process the data on the WEB server, and the processed results are transmitted from the WEB server to the computer 200.

The I/F 200I may include a Standard RS-232C serial interface, and has two ports: one connected with the control section 300 through an RS-232C cable and the other connected with the light source driver 400 through an RS-232C cable.

The control section 300 includes a motor driver 302 for driving the motor 112 adapted rotate the irradiation assembly 3 in the direction θ1, a motor driver 303 for driving the motor 35 adapted to rotate the irradiation arm 33 in the direction θ3, a motor driver 304 for driving the motor 111 adapted to rotate the sample table 21 in the direction θ1, and a motor driver 305 for driving the motor 225 adapted to rotate the sample table 21 in the direction θ2. The control section 300 also includes a motor controller 301 operable, in response to receiving various signals from an after-mentioned image-pickup mechanism control section 608, to output a pulsed signal for driving each of the motor drivers 302 to 305, and a control signal for instructing the motor drivers 302 to 305 to rotate the corresponding motor in the forward or reverse direction depending on the received signal. In response to receiving the pulsed signal and/or the control signal from the motor controller 301, each of the motor drivers 302 to 305 is operable to convert the received pulsed signal into pulsed power so as to energize a coil of the corresponding motor to drive the motor.

In response to receiving a control signal from the computer 200, the light source 400 is operable to generate a driving current, for example, having a level proportional to the intensity of the control signal, so as to turn on the light source unit 34.

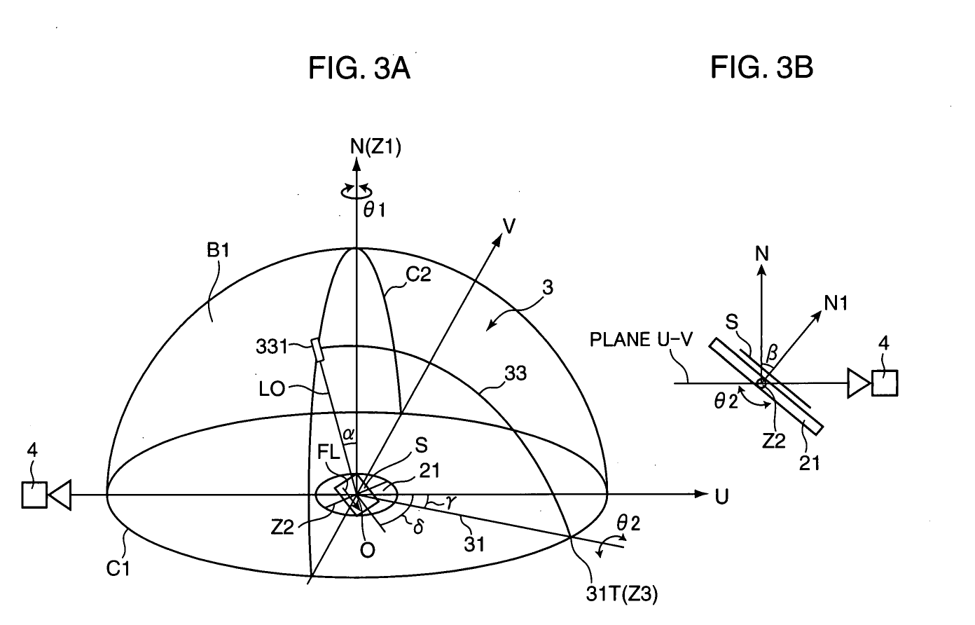

FIG. 3A is a schematic explanatory diagram of the structure of the shading-information acquisition device 100. FIG. 3B is a schematic explanatory diagram of the structure of the sample table 21. In the sample table 21, a rotation angle δ around the rotational axis Z1 is measured on the basis of an axis U. An angle designated by γ between the U axis and the support plate 31s a horizontal rotation angle of the irradiation assembly 3, and an angle designated by a between an axis N and a straight line LO connecting the radiation aperture 331 and an origin O is the rotation angle relative to the vertical direction (hereinafter referred to as “vertical rotation angle”) of the irradiation assembly 3. In FIG. 3A, the connection plate 32 is omitted only for the sake of simplicity in explanation.

In this embodiment, given that a fabric S is used as an actual sample, and mounted on the sample table 21 in such a manner that, when δ=0 (zero), the fibrous direction FL, of the fabric S becomes parallel to the axis U. Thus, the rotation angle δ of the sample table 21 relative to the axis U matches with an angle of the fibrous direction FL of the fabric S relative to the axis U. The rotation angle δ is the rotation angle relative to the horizontal direction (hereinafter referred to as “horizontal rotational angle”) of the sample table 21.

The support plate 31 is positioned by rotating the outer end 31 T thereof along the circumference C1 of a circle on the plane U-V by the rotation angle γ falling in the range of 0 (zero) to 360-degree. When the rotation angle y of the support plate 31 is zero, the irradiation arm 33 is positioned by rotating the radiation aperture 331 along a circular arc C2 on a plane N-V by the rotation angle a falling in the range of −90 to +90-degree. That is, the position of the radiation aperture 331 on a sphere-shaped plane B1 is determined by the rotation angles α and γ.

Given that the rotational axis Z2 is defined as a straight line intersecting with the fibrous direction FL at a right angle and passing through the origin O on the plane U-V, an angle between the axis N and an direction N1 orthogonal to the mounting surface of the sample table 21 is an angle β relative to the rotational axis Z2, or the vertical rotation angle of the sample table 21. The camera 4 is positioned such that its optical axis aligns with the axis U.

The image processing apparatus according to this embodiment is operable to acquire shading informations using these 4 kinds of rotation angles α, β, γ and δ as a parameter.

As described above, the shading-information acquiring device 100 is designed such that the sample table 21 can also be rotated in the direction θ2 about the rotational axis Z2. Thus, the same state as that when the camera 4 is moved along the sphere-shaped plane B1 can be created without actually moving the came 4 therealong. This makes it possible to eliminate any mechanism for moving the image pickup means, so as to simplify the structure of the device. In addition, while the camera 4 and the radiation aperture 331 designed to be moved along the sphere-shaped plane B1 will overlap with one another at a number of positions to cause difficulties in acquiring shading informations at these positions, the above shading-information acquisition device 100 having the camera 4 located at a fixed position can limit the number of such overlap positions to one or only the position of the image pickup hole 61.

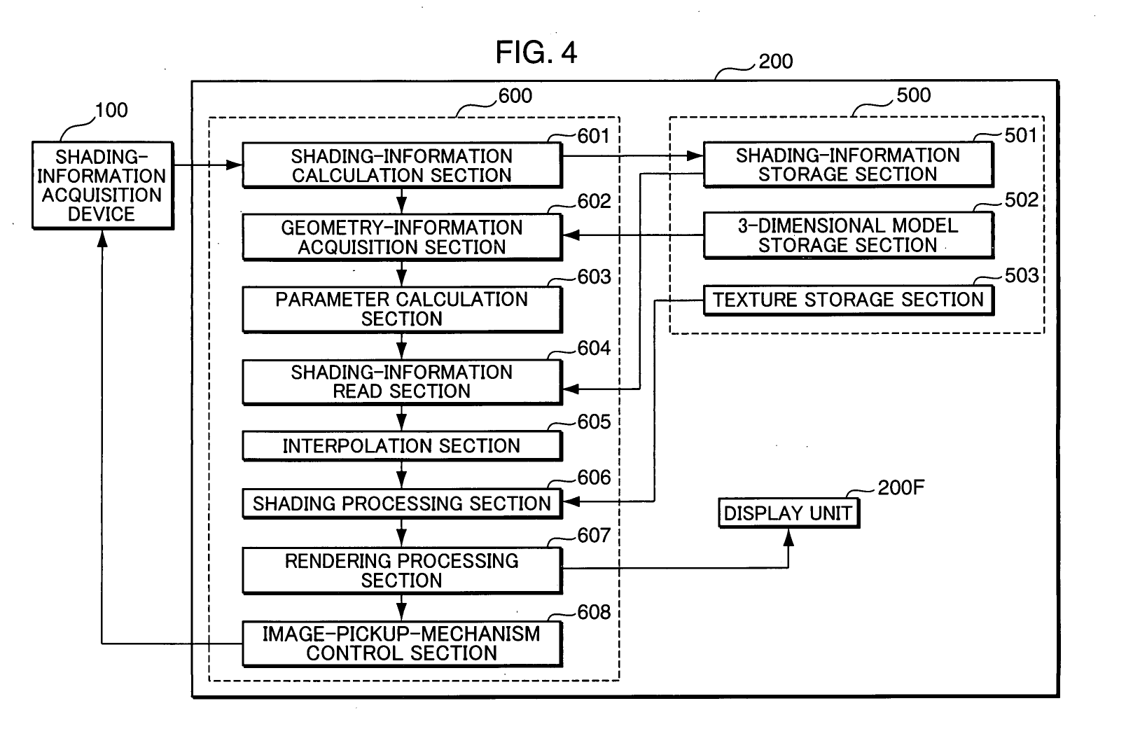

FIG. 4 is a functional block diagram of the computer 200. The image processing apparatus according to this embodiment comprises a storage unit 500 primarily composed of the RAM 200B and the auxiliary storage device 200H, and a program execution unit 600 composed of the CPU 200A. The CPU 200A is operable to execute the image processing program so as to achieve respective functions of these components. The storage unit 500 includes a shading-information storage section 501, a 3-dimensional model storage section 502, a texture storage section 503.

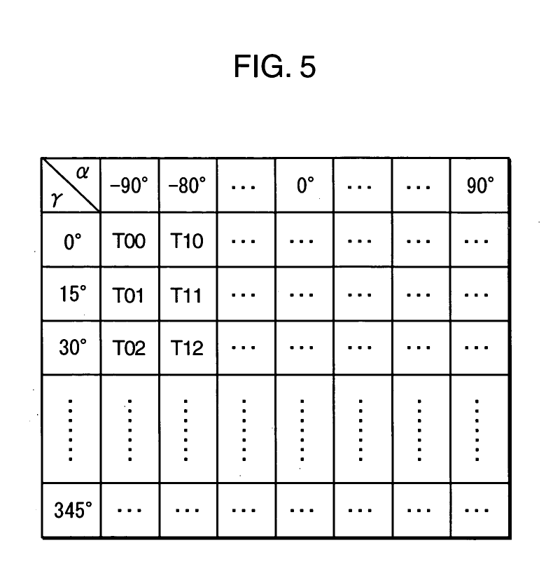

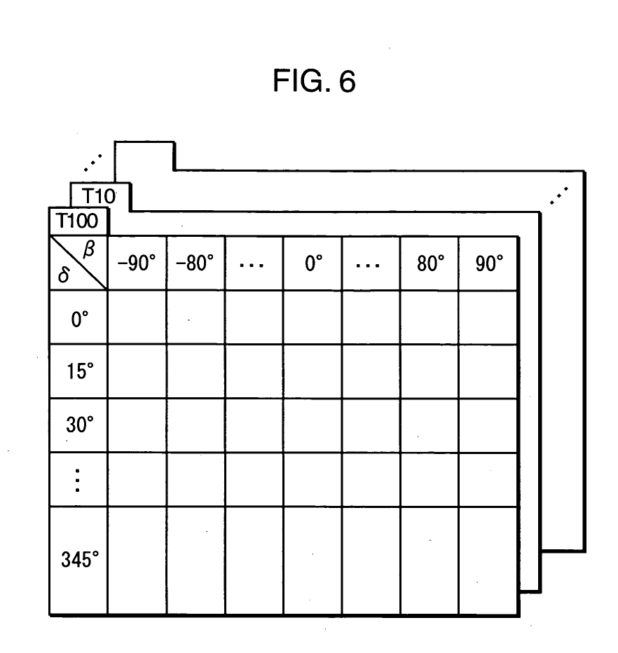

FIGS. 5 and 6 are explanatory diagrams of the data structure of the shading-information storage section 501. The shading-information storage section 501 has two kinds of first and second tables. FIG. 5 shows the first table, and FIG. 6 shows the second table.

The first table illustrated in FIG. 5 has a column heading for the vertical rotation angle a of the irradiation assembly 3, and a row heading for the horizontal rotation angle γ of the irradiation assembly 3. In the column heading for the rotation angle α, the values of the rotation angle a are described in the range of −90 to +90-degree, for example, in increments of 10-degree. In the row heading for the rotation angle γ, the values of the rotation angle γ are described in the range of zero to 345-degree, for example, in increments of 15-degree. Each of the cells in the first table stores thereon an index representing the second table specified by the respective values of the rotation angles α and γ. In FIG. 5, the index of the second table is expressed as the alphabet T plus a suffix of a column number and a row number of each of the cells. For example, the index T00 is stored on the cell of the column 0 and the row 0, and thus “00” is described as the suffix.

The second table illustrated in FIG. 6 is composed of a plurality of tables, and indexes are given to the tables, respectively. These indexes are associated with the respective indexes described in the cells of the first table. Each of the second tables has a column heading for the vertical rotation angle β of the sample table 21, and a row heading for the horizontal rotation angle δ of the sample table 21. In the column heading for the rotation angle β, the values of the rotation angle β are described in the range of −90 to +90-degree, for example, in increments of 10-degree. In the row heading for the rotation angle δ, the values of the angle δ are described in the range of zero to 345-degree, for example, in increment width of 15-degree. The shading informations are stored on the cells of the second tables, respectively.

While the tables in FIGS. 5 and 6 are configured to increase the values of the rotation angles α and β and the values of the rotation angles δ and γ, respectively, in increments of 10-degree and 15-degree, the present invention is not limited thereto, but the increment may be reduced or may be increased. Further, the increment width may be appropriately changed depending on the angle range. For example, each of the rotation angles may be increased in increments of 5-degree in the range of zero to 45-degree, and in increments of 10-degree in the range of 45-degree to 90-degree.

The 3-dimensional model storage section 502 stores thereon various data for specifying the shape of a virtual 3-dimensional model created in advance by an operator in a virtual 3-dimensional space set up on a computer, for example, the coordinate of each of the apexes of a polygon composed of a plurality of triangles, quadrangles or the like and attached on the surface of the virtual 3-dimensional model. The 3-dimensional model storage section 502 also stores thereon the respective coordinates of a virtual light source and a virtual camera which are arranged in the virtual 3-dimensional space. The virtual 3-dimensional space is represented as a coordinate system consisting of three axes N′, U′ and V′ corresponding to the axes N, U and V, respectively.

The texture storage section 503 stores a texture to be mapped onto the virtual 3-dimensional model. The plural kinds of textures are stored in the texture storage section 503, and an operator may select one or more of the textures to be mapped onto the virtual 3-dimensional model. In addition, the texture storage section 503 can store a texture created by an operator.

The program execution unit 600 includes a shading-information calculation section 601 a geometry-information acquisition section 602, a parameter calculation section 603, a shading-information read section 604, an interpolation section 605, a shading processing section 606, a rendering processing section 607 and an image-pickup-mechanism control section 608.

In response to receiving an image of an actual sample picked up by the shading-information acquisition device 100, the shading-information calculation section 601 is operable to set up a quadrangular-shaped region of n pixels×m pixel having a gravity center at a given position (e.g. center position) on the received image, and calculate each of average, maximum and minimum brightness values of the set-up region. The shading-information calculation section 601 is then operable to store the calculated average, maximum and minimum brightness values serving as shading information in the shading-information storage section 501, in association with the parameter values of the rotation angles α, β, γ and δ in the pickup operation of the received image.

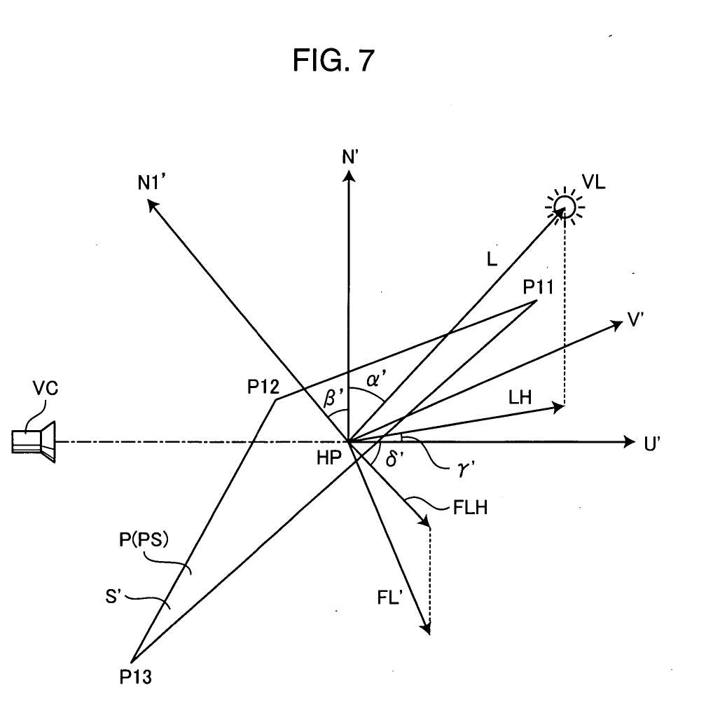

FIG. 7 is an explanatory diagram of the processing in the geometry-information acquisition section 602 and the parameter calculation section 603. A normal vector N1′ corresponds to N1 illustrated in FIGS. 3A and 3B, and angles α′, β′, γ′ and δ′ correspond, respectively, to the rotation angles α, β, γ and δ illustrated in FIGS. 3A and 3B. The polygonal surface PS of a polygon P corresponds to the surface of the actual fabric S (or the surface of the mounted sample). A target position HP corresponds to the origin O illustrated in FIG. 3A.

The geometry-information acquisition section 602 is operable to set up a target position HP at a given position on the surface of the virtual 3-dimensional model, and calculate a normal vector N1′ relative to the polygon surface PS in accordance with the respective coordinates of the apexes P11, P12, P13 of the polygon including the target position HP and a light-source vector L in accordance with the respective coordinates of the virtual light source VL and the target position HP. Then, the geometry-information acquisition section 602 will sequentially set up the target position HP over the entire surface of the virtual 3-dimensional model.

The parameter calculation section 603 is operable to calculate: the angle α′ between the light source vector L and a vertical vector N′; the angle γ′ between the axis U′ and an orthogonal projection vector LH of the light source vector L to a U′-V′ plane; the angle δ′ between the axis U′ and an orthogonal projection vector FLH of the an fibrous direction FL′ of a virtual fabric S′ set up on the polygon surface PS, to the U′-V′ plane; and the angle β′ between the normal vector N1′ and the vertical vector N′.

Based on the parameters consisting of the angles α′ to δ′ calculated by the parameter calculation section 603, the shading-information read section 604 is operable to read the shading information corresponding to the values of these parameters, from the shading-information storage section 501. If no shading information corresponding to the parameter values calculated by the parameter calculation section 603 exists in the shading-information storage section 501, the shading-information read section 604 will read the shading information corresponding to parameter values closest to the calculated parameter values. That is, the shading information is read based on approximate parameter values.

When the shading information corresponding to the approximate parameter values is read by the shading-information read section 604, the interpolation section 605 is operable to subject the read shading information to interpolation so as to calculate the shading information corresponding to the calculated parameter values. For example, if an angle α′ calculated by the parameter calculation section 603 is 42-degree, and the shading information is read using an angle α′ of 40-degree, the shading information stored on the cell adjacent to that storing the read shading information will be used to calculate the shading information corresponding to the angle α′ of 42-degree.

The shading processing section 606 is operable to subject the maximum, minimum and average brightness values of the acquired shading information to spline interpolation, using the shading information read by the shading-information read section 604 or acquired through the interpolation by the interpolation section 605, and the texture stored in the texture storage section 503, to allow the maximum, minimum and average brightness values of the texture to correspond, respectively, to the maximum, minimum and average brightness values of the acquired shading information, so as to calculate a correlation function between the acquired shading information and the texture, and then calculate a brightness value at the target position HP of the virtual 3-dimensional model using the calculated correlation function.

The rendering processing section 607 is operable to render the virtual 3-dimensional model on a virtual screen set up in the virtual 3-dimensional space, for example, using a ray tracing technique, so as to allow the rendered image to be displayed by the display unit 26.

The image-pickup-mechanism control section 608 is operable to output a control signal to the motor controller 301, so that the sample table 21 is moved relative to the rotational axes Z1 and Z2 by respective given angles, and the irradiation assembly 3 is moved relative to the rotational axes Z1 and Z3 by respective given angles, to locate them at intended positions. The image-pickup-mechanism control section 608 is also operable to control the light source unit 34 such that it supplies a driving current to the light source unit 34 so as to turn on the light source unit 34 at a given light intensity, for example, just before image pickup of the actual fabric S, and turns off the light source unit 34 after the completion of the image pickup.

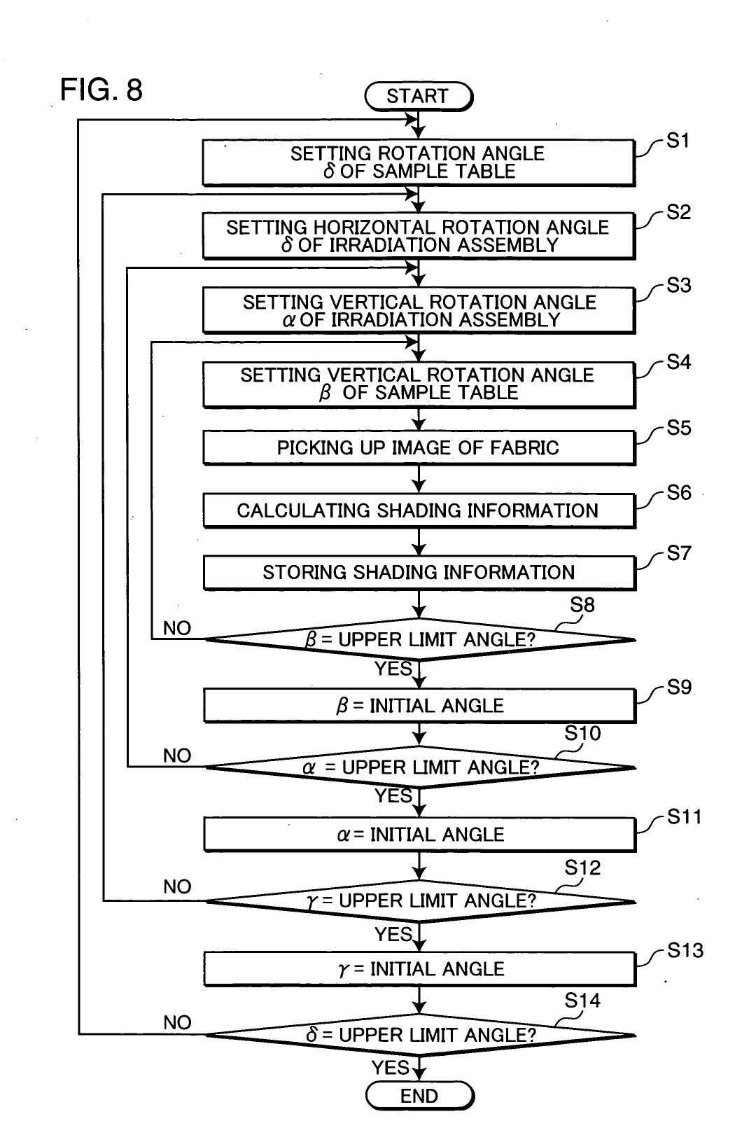

FIG. 8 is a flowchart showing a processing for picking up images of an actual fabric mounted on the sample table to acquire shading informations.

At Step S1, the image-pickup-mechanism control section 608 determines a given horizontal rotation angle δ of the sample table 21, and drives the motor 111 to rotate the sample table 21 by the given rotation angle δ.

At Step S2, the image-pickup-mechanism control section 608 determines a given horizontal rotation angle γ of the irradiation assembly 3, and drives the motor 112 to rotate the support plate 31 by the given rotation angle γ.

At Step S3, the image-pickup-mechanism control section 608 determines a given vertical rotation angle α of the irradiation assembly 3, and drives the motor 225 to rotate the irradiation arm 33 by the given rotation angle α.

At Step S4, the image-pickup-mechanism control section 608 determines a given vertical rotation angle β of the sample table 21, and drives the motor 225 to rotate the sample table 21 by the given rotation angle β.

In Steps S1 to S4, an operator can appropriately change the increment width of the rotation angles α to δ, using the input unit 200D.

At Step S5, the image-pickup-mechanism control section 608 outputs an control signal for instructing the light source driver 400 to turn on the light source unit 34, and, after turn-on of the light source unit 34 at a given light intensity, outputs an control signal for instructing the camera 4 to pick up an image of the actual fabric S. After the completion of image pickup, the image-pickup-mechanism control section 608 outputs a control signal for instructing the light source driver 400 to turn off the light source unit 34. While the image-pickup-mechanism control section 208 in the above embodiment turns on the light source unit 35 every time the sample table 21 and the irradiation assembly are positioned, it may be configured to continuously turn on the light source unit 34. This provides a simplified control of the light source unit 34.

At Step S6, the shading-information calculation section 601 acquires the image of the actual sample picked up by the camera 4, through the video capture board 200E. Then, the shading-information calculation section 601 sets up a certain region in the acquired image, and calculates the maximum, minimum and average brightness values in the set-up region. These calculated values are used as shading information.

At Step S7, the shading-information calculation section 601 associates the shading information calculated at Step S6, with the related image pickup condition (the rotation angles α, β, γ and δ), and stores it on the shading-information storage section 501.

At Step S8, the image-pickup-mechanism control section 608 determines whether the rotation angle β is an upper limit angle. When it is the upper limit angle (YES at Step S8), the rotation angle β is set up at an initial value (Step S9). If the rotation angle β is not the upper limit angle (NO at Step S8), the process will returns to Step S4 to set up the rotation angle β again. In this embodiment, the initial and upper limit values of the rotation angle β are set, respectively, at −90-degree and +90-degree, and the rotation angle β will be increased sequentially from −90-degree to +90-degree in increments of 10-degree.

At Step S10, the image-pickup-mechanism control section 608 determines whether the rotation angle a is an upper limit angle. When it is the upper limit angle (YES at Step S10), the rotation angle a is set up at an initial value (Step S11). If the rotation angle α is not the upper limit angle (NO at Step S11), the process will returns to Step S3. In this embodiment, the initial and upper limit values of the rotation angle a are set, respectively, at −90-degree and +90-degree, and the rotation angle a will be increased sequentially from −90-degree to +90-degree in increments of 10-degree.

At Step S12, the image-pickup-mechanism control section 608 determines whether the rotation angle γ is an upper limit angle. When it is the upper limit angle (YES at Step S12), the rotation angle γ is set up at an initial value (Step S13). If the rotation angle γ is not the upper limit angle (NO at Step S12), the process will returns to Step S2. In this embodiment, the initial and upper limit values of the rotation angle γ are set, respectively, at zero degree and 345-degree, and the rotation angle γ will be increased sequentially from zero degree to 345-degree in increments of 15-degree.

At Step S14, the image-pickup-mechanism control section 608 determines whether the rotation angle δ is an upper limit angle. When it is the upper limit angle (YES at Step S14), the process is completed. If the rotation angle δ is not the upper limit angle (NO at Step S14), the process will returns to Step S1. In this embodiment, the initial value of the rotation angle δ is set at zero degree, and the rotation angle δ will be increased sequentially up to 345-degree in increments of 15-degree.

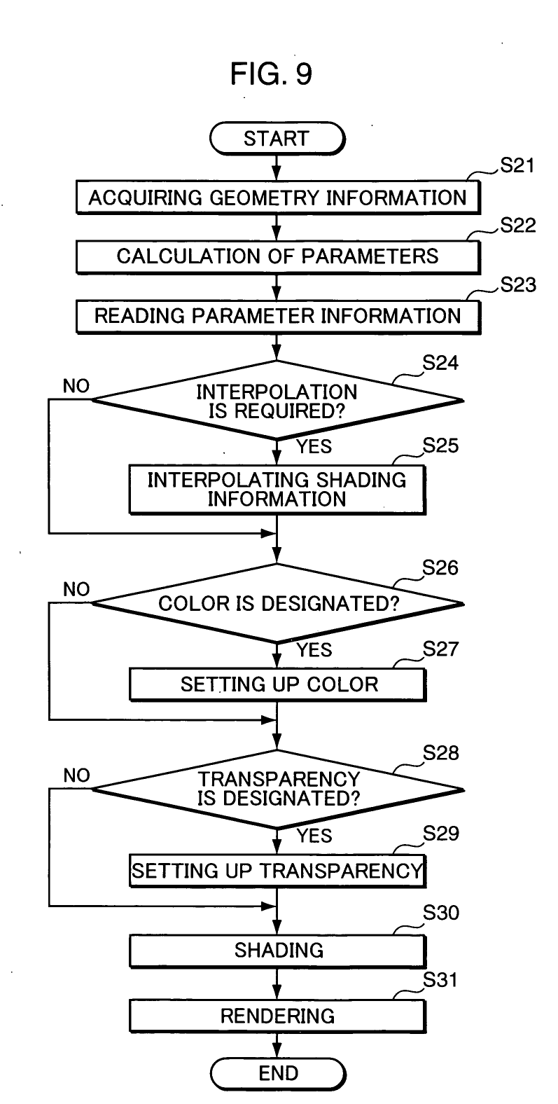

FIG. 9 is a flowchart showing a shading processing performed by the image processing apparatus. At Step S21, the geometry-information acquisition section 602 reads data stored in the 3-dimensional model storage section 502. Then, as shown in FIG. 7, the geometry-information acquisition section 602 sets up a target position HP on the surface of the 3-dimensional model, and calculates each of the normal vector N1′ and the light source vector L at the set-up target position HP.

At Step S22, as shown in FIG. 7, the parameter calculation section 603 calculates: the angle α′ at the target position HP in accordance with the light source vector L calculated at Step S21 and the vertical vector N′; the angle γ′ between the axis U′ and the orthogonal projection vector LH of the light source vector L to the plane U′-V′; the angle δ′ between the axis U′ and the orthogonal projection vector FLH of the fibrous direction FL′ of the virtual fabric S′ to the plane U′-V′; and the angle δ′ between the normal vector N1′ and the axis N′.

At Step S23, the shading-information read section 604 reads the shading information corresponding to the values of the four parameters α′, β′, γ′ and δ′ from the shading-information storage section 501. If no shading information corresponding to the four parameter values calculated at Step S22 exists in the shading-information storage section 601, the shading-information read section 604 reads the shading information corresponding to parameter values closest to the four parameter-values, from the shading-information storage section 501.

At Step S24, it is determined whether the shading information corresponding to the approximate parameter values is read at Step S23. When the shading information corresponding to the approximate parameter values is read (YES at Step S24), the interpolation section 605 subjects the shading information read at Step S23 to interpolation in accordance with the difference between the parameter values calculated at Step S22 and the approximate parameter values, and calculates the shading information corresponding to the parameter values calculated at Step S22. If it is determined as NO at Step S24, the process advances to Step S26 because no interpolation is required.

At Step S26, when a color for use in the shading is designated by an operator (YES at Step S26), the process advances to Step S27 to give the designated color to the read shading information (or shading information calculated through interpolation). If any color for use in the shading is not designated by the operator (NO at Step S26), the process advances to Step S28.

At Step S28, when an operator designates transparency to the shading (YES at Step 28), the process advances to Step S29. If the transparency is not designated by the operator (NO at Step S28), the process advances to Step S30.

At Step S30, the shading processing section 606calculates the brightness value of the target position HP in accordance with the shading information obtained at Steps S23 to S29, and one texture designated by the operator, among the plurality textures stored in the texture storage section 503.

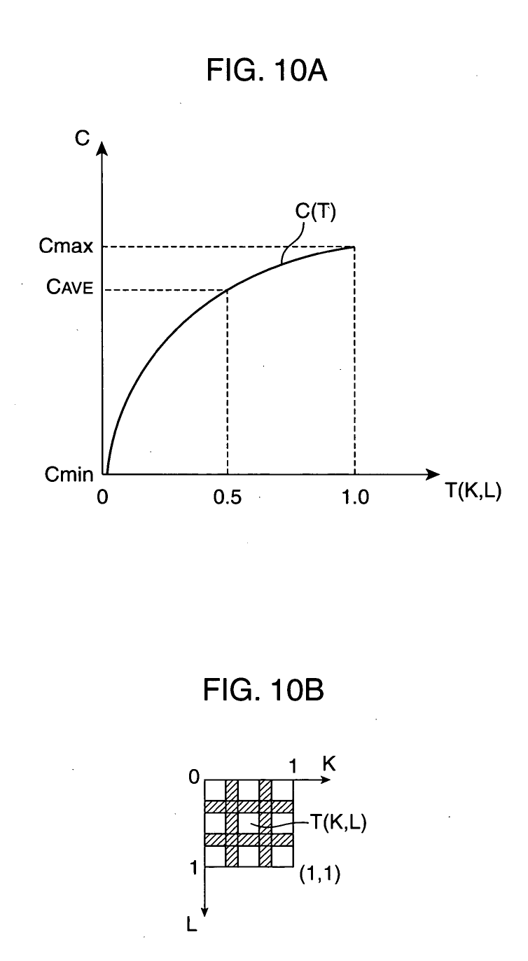

FIGS. 10A and 10B are explanatory diagrams of a processing performed by the shading processing section 606, wherein FIG. 10A is a graph showing the relationship between brightness C and texture brightness T, and FIG. 10B is an explanatory diagram showing one example of a texture stored in the texture storage section 503. C max, C ave and C min on the vertical axis in FIG. 10A indicate a maximum brightness value, an average brightness value and a minimum brightness value included in shading information, respectively. As shown in FIG. 10B, the texture storage section 103 has an origin located at the upper left corner edge of a foursquare texture where one side is 1, and the axes K and L extend along the upper edge and the left edge of the texture, respectively.

The shading processing section 606 correlates the maximum brightness value Cmax, the average brightness value Cave and the minimum brightness value Cmin included in the set-up shading information, respectively, with the maximum brightness value Tmax, the average brightness value Tave and the minimum brightness value Tmin of the texture, in such manner that the maximum brightness value Tmax, the average brightness value Tave and the minimum brightness value Tmin of the texture become 1, 0.5 and 0, respectively. This correlation can provide brightness values C corresponding to all of the brightness values T of the texture. Thus, more realistic shading processing can be performed. Then, the shading processing section 206 subjects three points Cmax, Cave and Cmin to spline interpolation, and calculates a correlation function between the brightness value C and the brightness value T of the texture so as to satisfy Cmin=b 0.

After the brightness value T (K, L) of the texture to be mapped onto the target position HP is determined, the shading processing section 606 assigns the brightness value T (K, L) to the correlation function C (T) to calculate the brightness value at the target position HP. Then, the target position is sequentially changed, and the above processing is repeatedly performed for each of new target position to apply the shading processing to the virtual 3-dimensional model. In this manner, the shading processing can be performed using the texture and the shading informations acquired by picking up images of the actual sample to re-create delicate quality of fabrics.

At Step S31, the rendering processing section 607 renders the virtual 3-dimensional model on a virtual screen set up in the virtual 3-dimensional space. The rendered image is displayed on the display unit 200F.

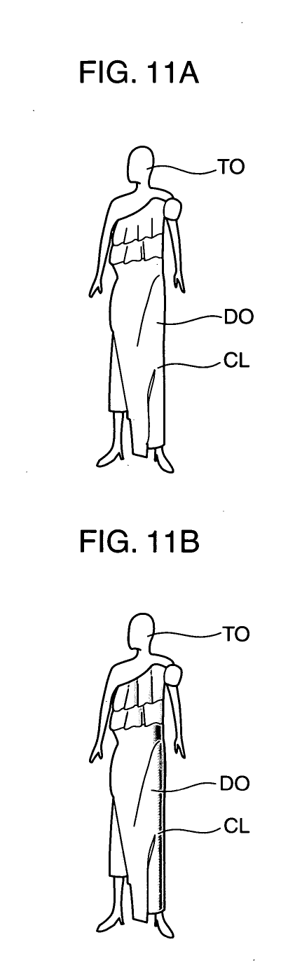

FIGS. 11A and 11B are explanatory diagrams of the effect of the image processing in the image processing apparatus, wherein FIG. 11A shows an image obtained through a shading processing using a conventional image processing apparatus, and FIG. 11B shows an image obtained through the shading processing using the image processing apparatus according to this embodiment. In both the images in FIGS. 11A and 11B, a virtual human model TO wears a red dress DO. As shown in FIG. 11A, while the dress DO according to the conventional image processing apparatus has some shading in the side of the waist, the entire surface of the dress DO is colored simply in red, and thus less of reality. By contrast, in the image processing apparatus according to this embodiment, the shading processing performed using images acquired by picking up an actual sample allows shading to be accurately expressed in consideration of the optical anisotropy of fabrics, and it is proved that pleats at the edge and chest area of the dress DO are realistically expressed, as shown FIG. 11B.

In the present invention, the following modes may be applied thereto.

While the image processing program in the above embodiment is installed in the computer 200, the present invention is not limited thereto, but the image processing program may be composed of hardware, such as LSI.

While the texture mapping in the above embodiment is performed using textures stored in the texture storage section 503, the texture mapping is not essential for the present invention but may be omitted. In this case, the shading processing section 606 may use only the average brightness value in the shading information, and a brightness value of the target point HP of the virtual 3-dimensional model may be set up correspondingly to the average brightness value.

The shading information acquired by picking up images of an actual sample in the image processing apparatus of the present invention may be used in a shading processing based on PTM (Polynomial Texture Mapping).

While the shading-information storage section 501 in the above embodiment stores the average, maximum and minimum brightness values calculated in accordance with an image of an actual sample picked up using camera 4, the present invention is not limited to such a configuration, but may be configured to store the image itself. In this case, the shading-information calculation section 601 may be designed to read the image from the shading-information storage section 501 and then calculate the average, maximum and minimum brightness values in accordance with the read image.

This application is based on Japanese Patent application No. 2003-348792 filed on Oct. 7, 2003, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A shading-information acquisition device for acquiring shading informations to be used in rendering a virtual 3-dimensional model which is created in a virtual 3-dimensional space, said shading-information acquisition device comprising:
a table for mounting an actual sample thereon, said table being adapted to be rotated by a given angle about a first axis extending in a direction orthogonal to the surface of said sample mounted thereon and to be rotated by a given angle about a second axis extending in a direction orthogonal to said first axis;
image pickup means for picking up an image of said actual sample mounted on said table, from a given direction; and
irradiation means for irradiating said actual sample with light, said irradiation means being adapted to move one end of the axis of said light along a sphere-shaped plane located above said table.

2. The shading-information acquisition device as defined in claim 1, wherein said irradiation means includes:
a first arm attached to said table in a rotatable manner about an axis extending in a vertical direction;
an arch-shaped second arm having a top end provided with a light radiation aperture, and the other end attached to said first arm in a rotatable manner about an axis extending in the longitudinal direction of said first arm;
a light source; and
light guide means for guiding light from said light source to said light radiation aperture.

3. The shading-information acquisition device as defined in claim 2, wherein said light guide means is an optical fiber cable including an optical fiber bundle.

4. The shading-information acquisition device as defined in claim 3, which further includes a dark box covering over the periphery thereof, wherein said light source and said image pickup means are disposed outside said dark box, and said dark box is formed with an image-pickup hole for allowing said image pickup means to pick up an image of said actual sample therethrough.

5. An image processing apparatus comprising:
a shading-information acquisition device for acquiring shading informations in accordance with images of an actual sample for respective image-pickup conditions defined by a parameter including an image pickup direction and a light radiation direction relative to said actual sample;
a processing device for rendering a virtual 3-dimensional model created in a virtual 3-dimensional space, in accordance with the shading information acquired by said shading-information acquisition device,
said processing device including:
shading-information storage means for storing the shading informations acquired by said shading-information acquisition device, in association with corresponding values of said parameter;
parameter calculation means for calculating a specific parameter value corresponding to a given region of said virtual 3-dimensional model, in accordance with the respective positions of a virtual camera and a virtual light source which are arranged in said virtual 3-dimensional space, and the shape of said region of said virtual 3-dimensional model; and
shading processing means for reading the shading information corresponding to said calculated parameter value from said shading-information storage means, and calculating a brightness value of said given region of said virtual 3-dimensional model, in accordance with said read shading information, and
said shading-information acquisition device including:
a table for mounting the actual sample thereon, said table being adapted to be rotated by a given angle about a first axis extending in a direction orthogonal to the surface of said sample mounted thereon and to be rotated by a given angle about a second axis extending in a direction orthogonal to said first axis;
image pickup means for picking up an image of said actual sample mounted on said table, from a given direction; and
irradiation means for irradiating said actual sample with light, said irradiation means being adapted to move one end of the axis of said light along a sphere-shaped plane located above said table.
